(19) United States
(12) Patent Application Publication
(10) Pub. No.: US 2025/0380835 A1
(43) Pub. Date: Dec. 18, 2025

(54) MULTI-CAVITY AIR FRYER

(71) Applicant: Sunbeam Products, Inc., Atlanta, GA (US)

(72) Inventors: Jose Betancourt, Lake Worth, FL (US); William Michael Kennedy, Wellington, FL (US)

(21) Appl. No.: 18/880,676

(22) PCT Filed: Jul. 19, 2023
(86) PCT No.: PCT/US2023/070502

§ 371 Date: Jan. 2, 2025

Related U.S. Application Data
(60) Provisional application No. 63/368,932, filed on Jul. 20, 2022.

(51) Int. Cl. A47J 37/06; F24C 15/32

(52) U.S. Cl. CPC A47J 37/0641; F24C 15/325

(57) ABSTRACT

A multi-cavity air fryer is provided that includes a main body having a cooking chamber where one or more cooking containers may be placed when an air frying function is carried out. A movable lid is hingedly attached to the main body. The cooking containers may be removed from the main body by way of an opening provided when the lid is opened. Similarly, when the lid is opened a user may check cooking progress without having to remove a cooking container from the cooking chamber.

### CROSS-REFERENCE TO RELATED APPLICATIONS

The present application claims priority to U.S. Provisional Patent Application No. 63/368,932, filed Jul. 20, 2022, the entire contents of which are hereby incorporated by reference.

### FIELD OF INVENTION

The present invention relates generally to a multi-cavity air fryer. More specifically, the invention relates to an air fryer with multiple cooking cavities that can be easily accessed through a lid on the air fryer.

### BACKGROUND OF INVENTION

Air fryers are becoming increasingly popular appliances for cooking food. Air fryers use hot convection air circulated around foodstuffs to crisp the food to emulate a traditional oil-frying cooking method. Air frying is less messy than traditional oil-frying methods, and it is much healthier.

Because of the advantages that air fryers offer, they have become staples in many homes. In fact, consumers often desire more than one air fryer so that they can use multiple air fryer appliances to cook their foods. As a result, at least one air fryer has been developed that includes two side-by-side cavities for air frying food, much like the side-by-side baskets seen in fast food kitchens for oil-frying French fries, breaded chicken, and the like.

However, the only way a user can inspect food in the existing multi-cavity air fryer systems is by removing one or both baskets in which the food is placed by pulling the basket(s) outwardly and away from the appliance. When an operator simply desires to check the cooking progress of her food, having to lift the baskets upon removing them from the appliance is cumbersome and unwieldly. Furthermore, it is undesirable to fully remove a basket from the appliance and its cooking chamber more often than necessary to avoid inconsistent cooking. The same principles apply when a consumer simply wishes to flip or stir the food in a basket.

Furthermore, when a user must slide a basket out of an appliance to view its contents, she risks burns from the basket itself or foodstuffs that fall from the basket.

### SUMMARY OF INVENTION

The present invention overcomes many of the shortcomings and limitations of the prior art devices discussed above. The invention described herein includes several embodiments of a multi-cavity air fryer.

In one embodiment, the present disclosure provides for an air fryer that includes multiple cooking cavities within a cooking chamber in the air fryer. The cavities can be used independently of one another. For instance, the first cavity can hold chicken to be cooked at 400 degrees for 15 minutes while the second cavity can hold green beans to be cooked at 350 degrees for 10 minutes. The multi-cavity air fryer provides the opportunity to cook the chicken and green beans simultaneously in adjacent cavities without interference from the adjoining cavities. In at least one embodiment, a divider which is used to separate the cooking chamber may be removed, and the two baskets used for side-by-side cooking may also be replaced with a single larger basket, tray, grill, plate, or insert. In that embodiment, a larger food batch may be cooked in a larger cavity that occupies the space of the entire chamber.

Rather than a drawer-style, the invention hereof includes a hinged lid on its upper portion. When the lid is opened, a user can easily view her food to ensure it is being properly cooked and, if necessary, remove it from the heat. Rather than requiring the user to pull out a drawer or basket, risk injury due to the high heat, carry the weight of the drawer or basket holding the food, or find a heat-resistant surface to place the drawer or basket, the user can simply open the lid above both (or just one) of the cavities to view the food. Then, if she wishes to remove the cooking container from the air fryer she may just pull it upwardly through the opening created between the lid and the main body of the air fryer.

### BRIEF DESCRIPTION OF DRAWINGS

FIG. 1 is a perspective view of a first embodiment of a multi-cavity air fryer constructed according to the teachings of the present application;

FIG. 2 is a cross-sectional view of the multi-cavity air fryer of FIG. 1; and

FIG. 3 is a perspective view of a second embodiment of a multi-cavity air fryer constructed according to the teachings of the present application.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

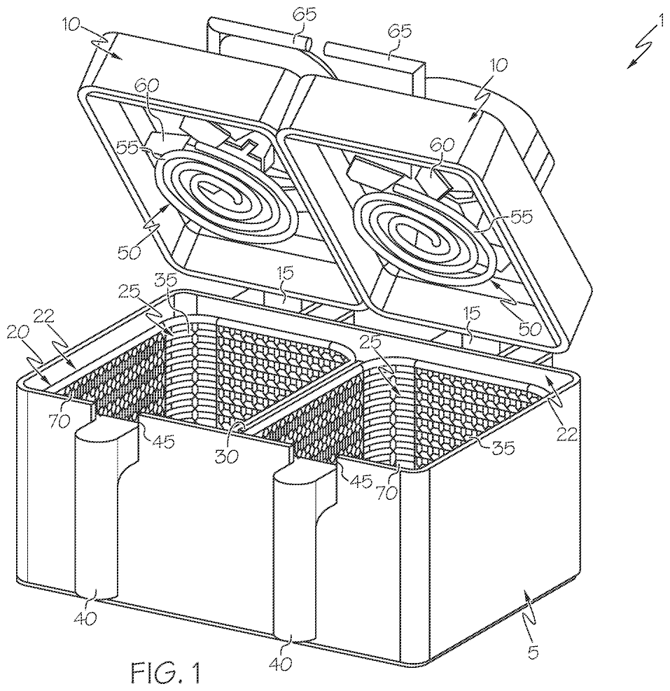

FIG. 1 illustrates a multi-cavity air fryer (or simply “air fryer”) 1 that may be used to air fry foodstuffs placed within the air fryer 1. The air fryer 1 includes a main body 5 and two movable lids 10 hingedly attached to the top of the main body 5 via hinge members 15. In some embodiments, one or both of the lids 10 may be transparent. In the case where the lid 10 is not transparent, a user may check the progress of foodstuffs being cooked in the air fryer 1 by simply opening the lid 10.

The main body 5 preferably includes one interior cooking chamber 20 in which one or more cooking containers 25 (which are smaller than the cooking chamber 20) may be received and secured. The cooking chamber 20 is preferably made of a heat-resistant material and may be removable from the main body 5. In the illustrated embodiment, the cooking chamber 20 includes two cavities 22 that are holding two cooking containers 25 separated from one another by a divider member 30. In some embodiments, the divider member 30 is permanent, while in other embodiments it is selectively removable (or detachable) from the cooking chamber 20.

When the divider member 30 is permanent, it may always keep a separation between the cavities 22 of the cooking chamber 20. In embodiments where the divider member 30 is selectively detachable from between the cooking chambers 20, the air fryer 1 may be used with one large cooking container, tray, grill, plate, or insert (not illustrated) contained in the cooking chamber 20. Alternatively, the cooking chamber 20 may be used as standalone, separate base for cooking food.

The cooking containers 25 may generally be formed as baskets that are preferably made of a heat-resistant material and are preferably configured to allow for air flow through them to carry out the convection cooking methods utilized during air frying. As such, each cooking container 25 may include many apertures 35 found along its surface for allowing air to flow therethrough.

In one embodiment, the cooking containers 25 include handle members 40 that extend beyond the outside of the cooking chamber 20 and the main body 5. The main body 5 may include cut-out portions 45 in which the handle members 40 may be retained. The handle members 40 preferably allow for a user to handle the cooking containers 25 more easily, for example when removing the cooking containers 25 from the cavities 22 of the cooking chamber 20 and access the food within them.

The illustrated air fryer 1 includes a plurality of heating assemblies 50 positioned and located within each movable lid 10. The heating assemblies 50 may be constructed using known means in the art. In one embodiment, the heating assemblies 50 comprise a heating element 55, a fan 60, and a motor (not illustrated) to drive the fan's rotation. The heating assemblies 50 are preferably configured to heat (and cook) the items in the cooking containers 25 in the cavities 22 in the cooking chamber 20. With the heating assemblies 50 positioned in the lids 10, the air fryer 1 takes up less counterspace than if the heating assemblies 50 were positioned on a side, front, or rear of the air fryer 1.

Each movable lid 10 is preferably lifted using handle members 65 attached to the lid 10. In one mode of operation, foodstuffs may be cooked within the cavities 22 separately at different temperatures and/or for different lengths of time. In the case where the air fryer 1 is being used to cook foodstuffs contained in the cooking containers 25 of the cavities 22 separately, the divider member 30 is preferably in place and substantially divides the cooking chamber 20 into two cooking regions 70, each of which are substantially in alignment with the lid members 10. The air fryer 1 may then be programmed to operate the heating element 55 and fan 60 of the two regions 70 of the cooking chamber 20 at a desired temperature, fan speed, etc. When a user lifts one of the lids 10 with a handle member 65 to view the contents within a region 70, the other lid 10 (if untouched) will remain closed, leaving the other region 70 undisturbed during cooking.

In a separate embodiment where foodstuffs are cooked in a cooking chamber 20 at the same temperature and length of time, the divider member 30 may be removed (but it does not have to be if, for example, cooking foodstuffs in two separate cooking containers 25). However, in one embodiment where the foodstuff is all cooked in a single cooking chamber 20 in a single cooking container (not illustrated), the handle members 65 may be connected as one handle member (not illustrated). For example, a sliding mechanism may be used to connect the handle members 65 to allow the user to easily open both lid members 10 at one time.

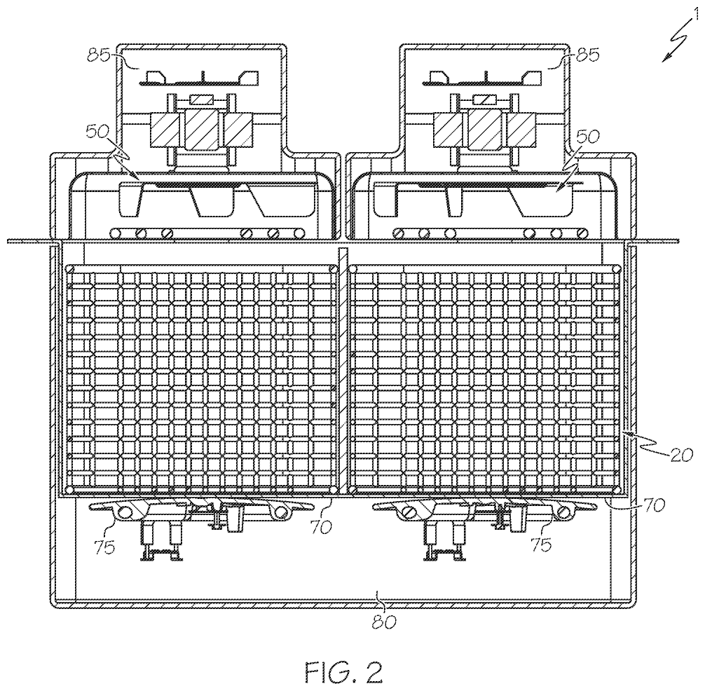

According to various embodiments and as illustrated in FIG. 2, additional heating assemblies 75 may be positioned on a bottom portion 80 of the air fryer 1. Such additional heating assembles 75 may be in addition to the heating assemblies 50 that are placed within the lid housing 85 of the air fryer 1. The heating assemblies 75 may be positioned within the air fryer 1 beneath the cooking chamber 20. In such embodiments, the heating assemblies 75 may conductively transfer heat to the cooking chamber 20 within air fryer 1. As illustrated, two heating assemblies 75 may be placed below the two cooking regions 70, each of which are substantially in alignment with the heating assemblies 75. More or fewer than two additional heating assemblies 75 may be used.

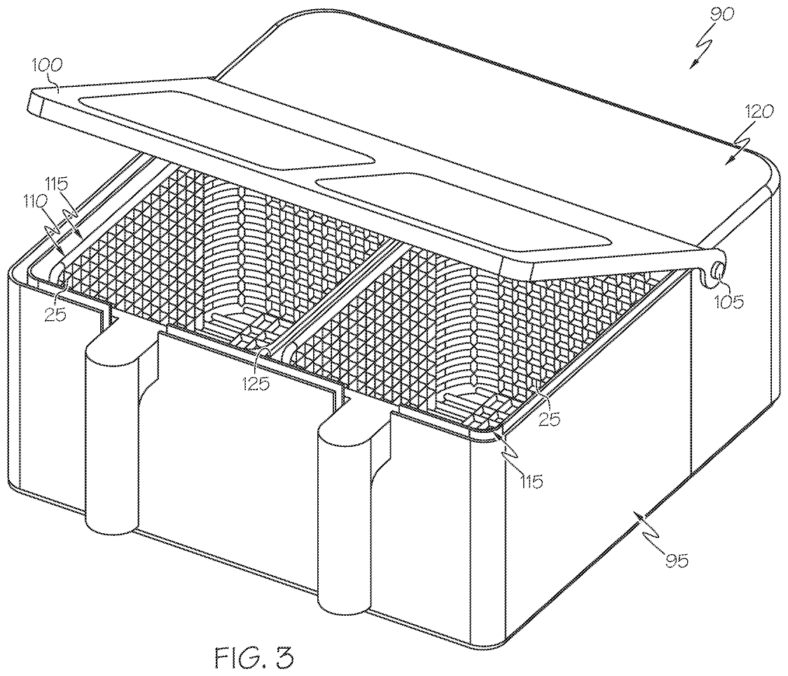

FIG. 3 illustrates a second embodiment of a multi-cavity air fryer, air fryer 90. The air fryer 90, like the air fryer 1, includes a main body 95 and a movable lid 100 hingedly attached to the main body 95 via a hinge member 105. While one lid 100 is provided in FIG. 3, the lid 100 may be provided as two or more lids (like the lids 10 of FIG. 1).

Like the air fryer 1, the air fryer 90 may include a cooking chamber 110 and two cavities 115, similar to the cooking chamber 20 and the cavities 22, respectively. In one embodiment, the cooking chamber 110 is heated using a heater assembly (not illustrated) inside the main body 95. More specifically, the heater assembly may be located at a rear portion 120 of the main body 95 rather than on the lid 100 as in the air fryer 1. With the heater assembly located at the rear portion 120, the air fryer 90 may not be as tall as the air fryer 1.

The heater assembly preferably directs heat and airflow into the cooking chamber 110 and the cavities 115 where it may encounter one or more cooking containers 25 like those of the air fryer 1. In one embodiment, the cooking chamber 110 includes a divider member 125, which may be permanent or detachable (as discussed with reference to FIG. 1). When multiple cooking containers 25 are used, the divider member 125 may be used to divide the cooking chamber 110 into two and create two cavities 115. Like the air fryer 1, when a user wishes to view the cooking progress of foodstuffs contained in the cooking chamber 110, she may simply open the lid 100 and look into the cooking chamber 110 without having to remove the container 25 or containers 25. Similarly, to remove a cooking container 25 from the cooking chamber 110 (for example, when flipping or stirring the foodstuffs), the user may simply lift it upwardly and out of the cooking chamber 110 with the lid 100 open.

As is evident from the foregoing description, certain aspects of the present invention are not limited by the particular details of the examples illustrated herein, and it is therefore contemplated that other modifications, applications, variations, or equivalents thereof, will occur to those skilled in the art. Many such changes, modifications, variations, and other uses and applications of the present constructions will, however, become apparent to those skilled in the art after considering the specification and the accompanying drawings. In addition, unless mention was made above to the contrary, it should be noted that all of the accompanying drawings are not to scale. All such changes, modifications, variations, and other uses and applications which do not depart from the spirit and scope of the present inventions are deemed to be covered by the inventions which are limited only by the claims which follow.

1. A multi-cavity air fryer comprising:
a main body including a cooking chamber and a plurality of cavities configured to receive one or more cooking containers;
a movable lid hingedly attached to the main body configured to selectively cover the main body; and
a heating assembly positioned and located in at least one of the following: the movable lid; a bottom portion of the main body; and a rear portion of the main body.

2. The multi-cavity air fryer of claim 1, further including a divider member that separates each of the one or more cooking containers from other cooking containers of the one or more cooking containers.

3. The multi-cavity air fryer of claim 1, wherein each of the one or more cooking containers contain a plurality of apertures configured for air to flow therethrough.

4. The multi-cavity air fryer of claim 1, wherein each of the one or more cooking containers contain a handle member.

5. The multi-cavity air fryer of claim 1, wherein the heating assembly comprises a heating element, a fan, and a motor, and wherein the motor is configured to drive rotation of the fan.

6. The multi-cavity air fryer of claim 1, wherein the heating assembly is configured to heat and cook foodstuffs contained within the one or more cooking containers.

7. The multi-cavity air fryer of claim 1, wherein foodstuffs contained within a first cooking container of the one or more cooking containers within a first cavity of the plurality of cavities is cooked at a different temperature or for a different length of time than foodstuffs contained within a second cooking container of the one or more cooking containers within a second cavity of the plurality of cavities.

8. The multi-cavity air fryer of claim 1, wherein the movable lid comprises a plurality of lids configured to cover the plurality of cavities, respectively.

9. A multi-cavity air fryer comprising:
a main body including a cooking chamber and a plurality of cavities configured to receive one or more cooking containers;
a plurality of lids hingedly attached to the main body configured to selectively cover the plurality of cavities, respectively; and
a heating assembly positioned and located in at least one of the following: the plurality of lids; a bottom portion of the main body; and a rear portion of the main body.

10. The multi-cavity air fryer of claim 9, further including a divider member that separates each of the one or more cooking containers from other cooking containers of the one or more cooking containers.

11. The multi-cavity air fryer of claim 9, wherein each of the one or more cooking containers contain a plurality of apertures configured for air to flow therethrough.

12. The multi-cavity air fryer of claim 9, wherein each of the one or more cooking containers contain a handle member.

13. The multi-cavity air fryer of claim 9, wherein the heating assembly comprises a heating element, a fan, and a motor, and wherein the motor is configured to drive rotation of the fan.

14. The multi-cavity air fryer of claim 9, wherein the heating assembly is configured to heat and cook foodstuffs contained within the one or more cooking containers.

15. The multi-cavity air fryer of claim 9, wherein foodstuffs contained within a first cooking container of the one or more cooking containers within a first cavity of the plurality of cavities is cooked at a different temperature or for a different length of time than foodstuffs contained within a second cooking container of the one or more cooking containers within a second cavity of the plurality of cavities.

16. The multi-cavity air fryer of claim 9, wherein the plurality of lids is connected via a sliding mechanism.

17. A multi-cavity air fryer comprising:
a main body including a plurality of cavities configured to receive one or more cooking containers;
a plurality of lids hingedly attached to the main body configured to selectively cover the plurality of cavities, respectively; and
a heating assembly positioned and located in each of the plurality of lids.

18. The multi-cavity air fryer of claim 16, further including a divider member that separates each of the one or more cooking containers from other cooking containers of the one or more cooking containers.

19. The multi-cavity air fryer of claim 16, wherein the heating assembly is configured to heat and cook foodstuffs contained within the one or more cooking containers.

20. The multi-cavity air fryer of claim 16, wherein foodstuffs contained within a first cooking container of the one or more cooking containers within a first cavity of the plurality of cavities is cooked at a different temperature or for a different length of time than foodstuffs contained within a second cooking container of the one or more cooking containers within a second cavity of the plurality of cavities.
